(19) United States
(12) Patent Application Publication
(10) Pub. No.: US 2009/0021881 A1
(43) Pub. Date: Jan. 22, 2009

(54) OVERVOLTAGE PROTECTION DEVICE WITH IMPROVED LEAKAGE-CURRENT-INTERRUPTING CAPACITY

(76) Inventor: Vincent Andre Lucien Crevenat, Izaux (FR)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(21) Appl. No.: 11/572,777

(22) PCT Filed: Jul. 25, 2001
(86) PCT No.: PCT/FR05/01916

§ 371 Date: Dec. 21, 2007

(30) Foreign Application Priority Data
Jul. 26, 2004 (FR) 0408251

(51) Int. Cl. H02H 3/22

(52) U.S. Cl. 361/111

(57) ABSTRACT

A device for protecting an electrical installation (2) against overvoltages, the device having a main spark-gap (E1) and a pre-triggering circuit (10) connected to the main spark-gap (E1) to control the firing of the main spark-gap in the event of any overvoltage. The pre-triggering circuit (10) has at least one voltage-interrupting element (G) which, in the off state, prevents current from passing through the pre-triggering circuit (10), so that, in the absence of an overvoltage, the leakage current consumed by the pre-triggering circuit (10) is essentially zero.

### PRIORITY CLAIM

This patent application is a U.S. National Phase of International Application No. PCT/FR2005/001916, filed Jul. 25, 2005, which claims priority to French Patent Application No. 0408251, filed Jul. 26, 2004, the disclosures of which are incorporated herein by reference in their entirety.

### FIELD OF THE INVENTION

The present invention relates to devices for protecting electrical equipment or installations against voltage disturbances such as surges, and in particular transient overvoltage due, for example, to lightning strikes. The present invention relates more specifically to a device for protecting an electrical installation against voltage surges, in particular transient overvoltage due to a lightning strike.

### BACKGROUND OF THE INVENTION

Devices for protecting electrical installations against overvoltage are widely used and often designated as “lightning arresters”. Their essential purpose is to earth the lightning strike current and possibly clip the additional voltage induced by these currents down to levels that are compatible with those of the equipment and appliances to which they are connected.

A lightning arrester spark gap is already known, comprising a main spark gap, to protect an installation against voltage surges. The main spark gap is, for example, positioned between the phase to be protected and the earth so as to permit, in the event of a voltage surge, the lightning strike current to flow to earth.

The control of the arcing of the main spark gap using a pre-triggering circuit is also known. The output of the pre-triggering circuit may be connected directly to one of the main electrodes of the main spark gap. It can also be envisaged to equip the main spark gap with a pre-triggering element, generally formed by an arc striking electrode, to which the pre-triggering circuit is connected. The protection devices that incorporate such a pre-triggering circuit advantageously permit an arc striking across the spark gap at a voltage lower than those of protection devices without such a circuit.

Known pre-triggering circuits may comprise several components whose respective values are selected to obtain a given level of protection. In this way, one may classically employ nonlinear protection elements, such as varistors, offering a lower level of protection than the main spark gap and which, when associated to a current transformer, for example, permit the arcing of the main spark gap to be controlled by voltage levels lower than the intrinsic triggering voltage level of the main spark gap. The recourse to other components is also known, such as a capacitor, wherein operation of the pre-triggering circuit is based on the charge of the capacitor.

While such devices permit the arcing voltage of the main spark gap of the protection device to be efficiently reduced, the devices suffer from several considerable disadvantages.

Firstly, in the absence of an overvoltage, known protection devices are traversed by a leakage current that circulates in the pre-triggering circuit when powered at its permanent voltage. However, the existence of such a leakage current may interfere with the sensitive electronic systems downstream of the protection device, such as, for example, low power differential circuit breakers or insulation testing devices.

Furthermore, pre-triggering circuits that operate on the principle of a capacitor charge suffer from a trigger lag effect due to the charging time of the capacitor.

Consequently, known protection devices cannot be completely efficient and have a certain number of weaknesses, in particular, associated with the design of the pre-triggering circuit.

### SUMMARY OF THE INVENTION

The features provided by the present invention overcome the various previously-mentioned disadvantages and provide a new device for protecting an electrical installation against voltage surges, wherein the new device, in the absence of overvoltage, consumes substantially no leakage current.

A feature of the present invention is a device for protecting an electrical installation against overvoltage, wherein the device is equipped with a pre-triggering circuit that permits the arc striking voltage of the spark gap to be reduced.

Another feature of the present invention is a device for protecting electrical installations against overvoltage, wherein the device is equipped with a pre-trigger circuit designed to prevent, in the absence of voltage surges, the circulation of current in the protection device.

Another feature of the present invention is a device for protecting electrical installations against overvoltage, wherein the device permits the reduction and subsequent elimination of the current circulating in the pre-trigger circuit once the spark gap arc has struck.

Another feature of the present invention is a device for protecting electrical installations against overvoltage, wherein the device permits overvoltage to be earthed while maintaining a level of protection compatible with traditional electrical equipment.

Another feature of the present invention is a device for protecting electrical installations against overvoltage, wherein the device offers improved operating safety.

Another feature of the present invention is a device for protecting electrical installations against overvoltage, wherein all of the lightning strike current passes through the spark gap.

The described features of the present invention are achieved by means of a device that protects electrical installations against overvoltage, particularly transient overvoltage caused by lightning strikes, wherein the device bypasses the electrical installation and comprises a spark gap and a pre-trigger circuit, that is sensitive to overvoltage. The pre-trigger circuit bypasses the electrical installation and connects to the spark gap so that the pre-trigger circuit controls the arcing when an overvoltage occurs. The pre-trigger circuit also comprises at least one voltage cut-off element, specifically designed to change state, when the voltage at the terminals exceeds a pre-determined threshold value, from a non-conductive state, in which the voltage cut-off element prevents current from circulating, to a conductive state, in which the voltage cut-off element permits current to circulate. The voltage cut-off element prevents, in the non-conductive state, the current from circulating in the pre-trigger circuit so that, in the absence of a voltage surge, the current consumed by the pre-trigger circuit is substantially nil.

### BRIEF DESCRIPTION OF THE DRAWINGS

Other specific features and aspects of the invention will become clear in detail after reading the description and referencing the drawings, which are provided by way of illustration and are in no way restrictive.

FIG. 1 is a schematic diagram showing one exemplary embodiment of an overvoltage protection device according to the present invention;

FIG. 2 is a schematic diagram showing a second exemplary embodiment of the overvoltage protection device according to the present invention.

FIG. 3 is an electrical diagram showing a third exemplary embodiment of the overvoltage protection device according to the present invention.

FIG. 4 is a diagram showing one specific layout of the components used in the overvoltage protection device according to the present invention.

FIG. 5 is an electrical diagram showing a fourth exemplary embodiment of the overvoltage protection device according to the present invention.

### DESCRIPTION OF THE INVENTION

The overvoltage protection device in accordance with the present invention is designed to bypass the electrical equipment or installation to be protected.

For purposes of the present disclosure, the term “electrical installation” refers to any appliance or system likely to be subjected to voltage disturbances, in particular transient overvoltages due to lightning strikes. Such overvoltage protection devices are commonly referred to as “lightning arresters”.

The overvoltage protection device in accordance with the present invention is advantageously designed to be positioned between one phase of the installation to be protected and the earth (ground). Furthermore, it may be envisaged, without this being outside of the scope of the invention, that the device, instead of being connected between one phase of the installation and the earth, be connected between the neutral and the earth, between the phase of the installation and the neutral, or between two phases of the installation (differential protection).

Among overvoltage protection devices commonly used, we commonly identify voltage cut-out elements and voltage limiting elements, whose characteristics are defined in the CEI-6 643.1 standard known to those skilled in the art.

The voltage cut-off elements are, in the scope of the present invention, components likely to change from a non-conducting state, in which the voltage cut-off elements prevent current from circulating, to a conducting state, in which the voltage cut-off elements permit current to circulate. The current passing through the components increases very rapidly after arcing, whereas the voltage at the terminals reduces very quickly. Spark gaps or thyristors are, in the scope of the present invention, voltage cut-off elements.

On the contrary, voltage limiting elements have an ascending voltage-current curve, where the voltage at the terminals of the components remains substantially constant or increases slightly as the current increases. In fact, when a given voltage threshold is reached, current increases rapidly in the voltage limiting element due to the reduction of the resistance, whereas the voltage at the terminals remains more or less constant. Zener diodes and varistors are, in the scope of the present invention, voltage limiting elements. In the following description, the expressions “voltage cut-off element” and “voltage limiting element” are to be understood in accordance with the above-mentioned definitions.

FIG. 1 and FIG. 5 illustrate a protection device 1 in accordance with a first exemplary embodiment of the present invention. As illustrated in FIGS. 1 and 5, protection device 1 is shunted in relation to the electrical installation 2 to be protected. The examples in FIGS. 1-5 show a protection device 1 shunted between the phase of the installation to be protected P and the earth T.

In the present invention, protection device 1 comprises a main spark gap E1, for example, an air spark gap, equipped with two main electrodes 3, 4 separated by an isolating medium 5, such as air, in which the electrical discharge occurs via an electrical arc between the main electrodes 3, 4. The main spark gap E1 is fitted in parallel to the electrical installation 2 to be protected.

In the present invention, and as shown in FIG. 1, protection device 1 also comprises a pre-triggering circuit 10 (shown in dotted lines) that is sensitive to overvoltage and, in particular, to the voltage at terminals 10A, 10B. The pre-triggering circuit 10 is shunted in respect to electrical installation 2 and is connected to the main spark gap E1 so that arcing of spark gap E1 is controlled when an overvoltage occurs.

In a first exemplary embodiment of the present invention, illustrated in FIG. 1, the main spark gap E1 is equipped with a pre-triggering element 6 that permits the main spark gap to be triggered, the pre-triggering element 6 is preferably an arcing electrode. Classically, the arcing at the spark gap E1 takes place when the voltage between the pre-triggering element 6 and one of the main electrodes 3, 4 exceeds a certain value.

In this exemplary embodiment, the pre-triggering circuit 10 connects to the pre-triggering element 6 and is designed so that, when a current passes through it, the voltage at the output S is largely identical between one of electrodes 3, 4 and the pre-triggering element 6.

In a second exemplary embodiment of the present invention, illustrated in FIG. 5, the main spark gap E1 does not have a third pre-triggering electrode, and the arc is struck when the voltage between the main electrodes 3, 4 exceeds a certain value.

In this exemplary embodiment, the pre-triggering circuit 10 connects to one of the main electrodes 3, 4 and generates, in the event of an overvoltage, a voltage higher than the intrinsic triggering voltage of the main spark gap E1.

In the present invention, the pre-triggering circuit 10 comprises at least one voltage cut-off element G, such as a spark gap or a thyristor, specifically designed to change, when the voltage at the terminals exceeds a pre-determined threshold value, from a non-conductive state, in which the voltage cut-off element G prevents the current from circulating, to a conductive state, in which the voltage cut-off element G permits current to pass.

In FIGS. 1-3 and 5, the voltage cut-off element G is shown by a spark gap symbol.

However, within the scope of the invention, the spark gap symbol may be exchanged for another voltage cut-off element, such as a thyristor.

In one feature of the present invention, the voltage cut-off element G is positioned in the pre-triggering circuit 10 to prevent, when in a non-conductive state, current from circulating in the pre-triggering circuit 10, so that in the absence of a voltage surge, any leakage current consumed by pre-triggering circuit 10 is substantially nil.

Within the scope of the present invention, a “leakage current” is a current likely to power the protection device 1 in normal operation, i.e., in the absence of a voltage surge. Thus, thanks to the specific assembly of the pre-triggering circuit 10 and the electrical layout of the voltage cut-off element G in the pre-triggering circuit 10, the leakage current consumed by the protection device 1 is substantially nil.

Such a device permits the risk of damage to sensitive electrical appliances located downstream of the protection device 1 to be significantly reduced. The protection device according to the present invention will now be described in reference to FIGS. 1 and 5.

Advantageously, the pre-triggering circuit 10 comprises a triggering transformer TR equipped with a primary coil L1 and a secondary coil L2 which are magnetically coupled. In the first exemplary embodiment illustrated in FIG. 1, the secondary coil L2 is connected, preferably directly, to the pre-triggering element 6 so that when the primary coil L1 is crossed by a current, in particular, a lightning strike current, the voltage induced at the terminals of the secondary coil L2 causes an arcing of main spark gap E1.

In the second exemplary embodiment illustrated in FIG. 5, the secondary coil L2 is connected, preferably directly, to one of the main electrodes, 3, 4 so that the secondary coil L2 may cause an arc at the main spark gap E1.

In accordance with a classical transformer architecture, the secondary coil L2 advantageously comprises a greater number of windings than that of the primary coil L1, so that the voltage at the terminals of the secondary coil of the transformer is substantially higher than the voltage at the terminals of the primary coil.

In one particularly advantageous feature of the present invention, the pre-triggering circuit 10 comprises a branch B connected in parallel to the electrical installation 2 and to the main spark gap E1.

In one especially advantageous exemplary embodiment, and as shown in FIGS. 1-3 and 5, branch B comprises the primary coil L1 and connected in series with the primary coil L1 is a voltage cut-off element G.

The voltage cut-off element G is specifically positioned so that, in the absence of an overvoltage, the leakage current is substantially nil not only in branch B, but also in the entire pre-triggering circuit 10.

The voltage cut-off element G is advantageously positioned in the pre-triggering circuit 10, so that all the current I, and in particular the lightning strike current, which enters pre-triggering circuit 10 necessarily crosses voltage cut-off element G. In one preferred exemplary embodiment of the present invention, illustrated in FIGS. 1-3 and 5, the pre-triggering circuit 10 comprises at least one voltage limiting element V1 connected in series with voltage cut-off element G. This voltage limiting element V1 is preferably formed by a varistor.

The voltage limiting element V1 is mounted in series with the voltage cut-off element G and with the primary coil L1, which permits the current circulating in the primary coil L1 of the transformer TR to be limited. Consequently, when the main spark gap E1 arcs, the main spark gap E1 takes the majority of the lightning strike current. However, it is possible that part of the lightning strike current flows through the pre-triggering circuit 10, from the phase of the installation to be protected P to the earth T, especially in the primary coil L1 of the transformer TR. One consequence of this phenomenon could be to irreparably damage the pre-triggering circuit 10, which is not a priori designed to discharge a lightning strike current. The use of a voltage limiting element V1 positioned in series with the voltage cut-off element G allows the intensity of the current circulating in the pre-triggering circuit 10 to be limited, and to cut-off the current conducted by voltage cut-off element G, which means, in the case where voltage cut-off element G is a spark gap, that the lightning strike current conducted by the spark gap G is cut off.

Within the scope of the present invention, the leakage current is the short circuit current that the spark gap continues to conduct after an arc has been struck and until the electrical arc is extinguished.

The voltage limiting element V1 does not intervene in the triggering of the main spark gap E1 but is positioned in the pre-triggering circuit 10 so that the voltage limited element operates with voltage cut-off element G to extinguish the current conducted by voltage cut-off element. Thereon, the voltage limiting element V1 has different characteristics and, in particular, consumes much less energy than the voltage limiting elements traditionally used to trigger a spark gap arc in devices of prior art.

In these conditions, the majority of the energy from the surge in voltage is absorbed by the main spark gap E1, whereas, in the devices of the prior art, a significant part of the energy from the voltage surge was consumed by the pre-triggering circuit, especially by non-linear triggering components such as varistors. The current-voltage feature of voltage limiting element V1 is, therefore, specifically chosen to suit the feature of voltage cut-off element G. In practice, the value of the operating voltage of the voltage limiting element V1 used in the scope of the present invention is considerably lower than the operating voltage of the voltage limiting elements traditionally used to trigger an arc in a spark gap.

By way of example, for an electrical installation 2 operating at a nominal voltage of 230 V and a frequency of 50 Hz, one can use, to trigger a main spark gap E1 with an intrinsic triggering voltage, which is to say without pre-triggering, of around 3.5 to 4 kV, a voltage cut-off element G of the spark gap type with a threshold value of around 800 V, a voltage limiting element V1 of the varistor type with an operating voltage of around 150 V and a transformer with a primary coil L1 of 12/H and a secondary coil L2 of 4 mH. It is interesting to note that if a varistor is used to trigger the main spark gap E1 instead of the voltage cut-off element G, the operating voltage of this varistor would have to be increased to at least 255 V (nominal voltage 230V of mains system+10%) and would, therefore, consume much more energy than the voltage limiting element V1 used in the scope of the present invention.

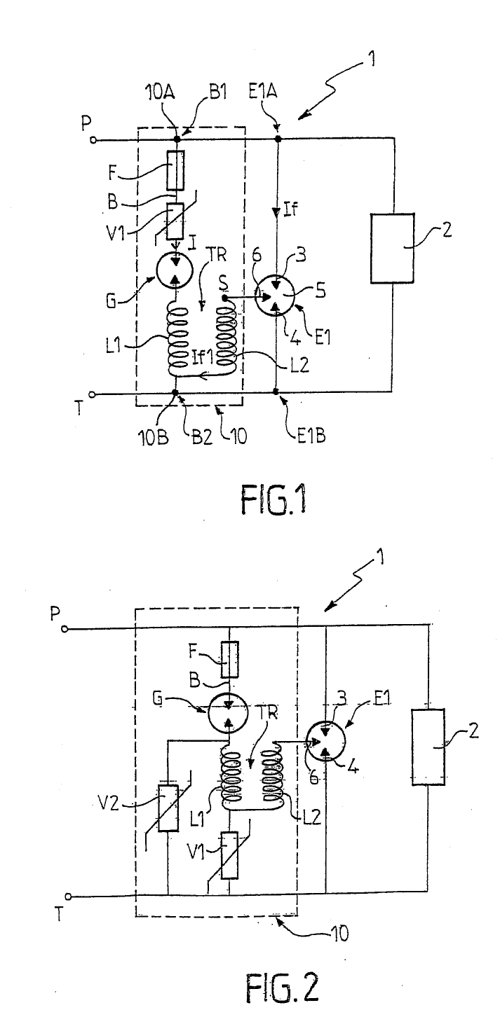

In one preferred exemplary embodiment of the present invention illustrated in FIG. 2, the pre-triggering circuit 10 advantageously comprises at least one additional voltage limiting element V2, of the varistor type, connected in parallel with the primary coil L1. The additional voltage limiting element V2 may advantageously either be mounted in parallel with the single primary coil L1, or be mounted in parallel with the primary coil L1 and the associated voltage limiting element V1 in series, as shown in FIG. 2. The voltage limiting element V2 permits the maintaining of a voltage that is compatible with the operation of the electrical equipment connected downstream of the protection device and at the terminals of the protection device 1. Of course, the additional voltage limiting element V2 is advantageously positioned in the pre-triggering circuit 10 so that it only conducts a current when voltage cut-off element G is in the conductive state. Preferably, the additional voltage limiting element V2 is mounted in series with voltage cut-off element G.

By way of illustration, the additional voltage limiting element V2 may be formed by a varistor having an operating voltage of around 275 V.

In one preferred exemplary embodiment of the present invention, illustrated in FIGS. 1-3 and 5, the pre-triggering circuit 10 advantageously comprises at least one component to protect against overvoltage F, and is connected in series with the voltage cut-off element G.

Preferably, the component protecting against overvoltage F is a thermal fuse physically positioned against the varistor that forms the voltage limiting element V1. The thermal fuse forms a means for thermal disconnection of the voltage limiting element in the event of overheating.

In the exemplary embodiments of the present invention illustrated in FIGS. 1 and 5, the pre-triggering circuit 10 is solely composed of a transformer TR, a voltage cut-off element G, a voltage limiting element V1 and a component to protect against overvoltage F, excluding all other components, and more especially excluding a capacitor.

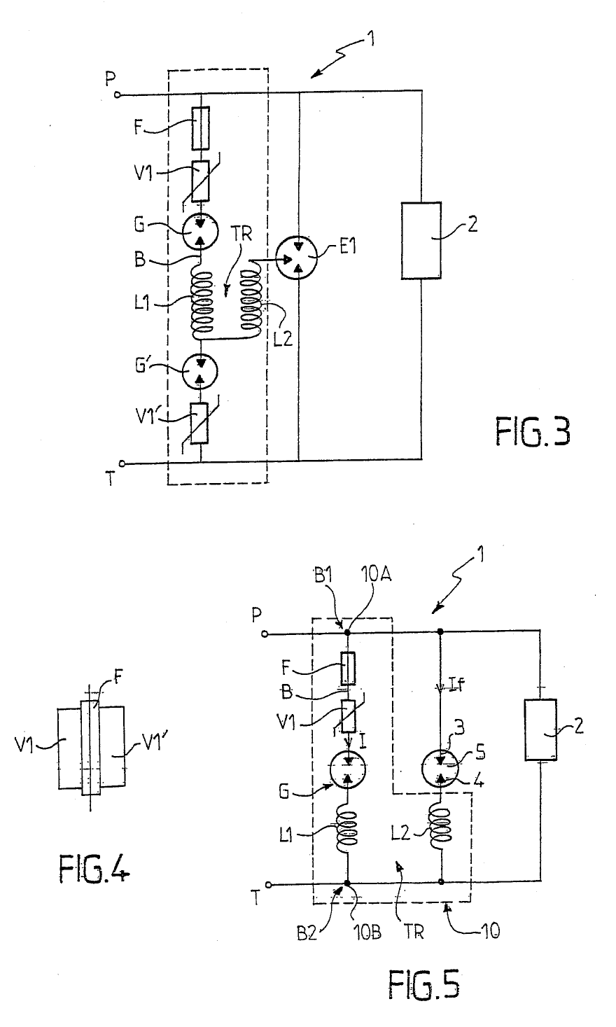

In another exemplary embodiment of the present invention illustrated in FIG. 3, the pre-triggering circuit 10 comprises, mounted in series with the primary coil L1 of the transformer TR, two voltage cut-off elements G, two voltage limiting elements V1, V1′ and a component to protect against overvoltage F, more precisely a thermal fuse. In this case, the branch B connected in parallel to the main spark gap E1 is solely composed of the primary coil L1, the two voltage limiting elements V1, V1′ the two voltage cut-off elements G, G′ and the component to protect against overvoltage F.

Of course, it can also be envisaged, in the scope of the present invention, to provide the pre-triggering circuit 10 with a second component protecting against surges in voltage, so that each component protecting against overvoltage is associated with a given voltage limiting element.

Even more preferably, the two voltage cut-off elements G, G′ are mounted in series on either side of the primary coil L1, wherein the primary coil is electrically connected between a first voltage cut-off element G and a second voltage cut-off element G′. The two voltage limiting elements V1, V1′ are respectively connected in series with the cut off elements G, G′.

Such a set up permits, especially in the case of the exemplary embodiment illustrated in FIG. 1, avoiding that part of the lightning current flows in the secondary coil L2 of the transformer TR, from the phase of the installation to earth, once the main spark gap E1 has arced.

In fact, if we look at the diagram of FIG. 1, we can see that once the main spark gap E1 has arced, one part, “If1”, of the lightning current “If” circulating in the main spark gap E1, is likely to return to earth passing through the secondary coil L2 of the transformer TR. The present invention permits, by disposing a second voltage cut-off element G′ between the secondary coil L2 and the earth T the elimination of this derived current. The secondary coil L2 is connected, by one of the terminals, to the pre-triggering device 6 and by the other terminal to the voltage cut-off element G′.

The voltage cut-off elements G, G′ are positioned electrically on either side of the primary coil L1 so that transformer TR is isolated from the rest of the pre-triggering circuit 10, thus avoiding any current leaking into the circuit once the main spark gap E1 has arced.

Another feature of this setup is that the setup is symmetrical, so that the protection device 1 is not sensitive to the polarity of the voltage at the terminals and behaves in the same way, regardless of the manner in which the protection device is connected between the phase of the installation and the earth.

In one preferred exemplary embodiment of the present invention illustrated in FIG. 4, the device for protecting against overvoltage F, specifically the thermal fuse, is positioned between the two voltage limiting elements V1, V1′ and is in thermal contact with the two voltage limiting elements V1, V1′. If one of these voltage limiting elements V1, V1′ is defective and abnormally overheats, the two voltage limiting elements V1, V1′ will be disconnected from the rest of the pre-triggering circuit 10.

Preferably, all of the voltage cut-off elements G, G′ are formed by spark gaps and all of the voltage limiting elements V1, V1′ are formed by varistors.

The operation of the protection device in accordance with the present invention will now be described in reference to the setup illustrated in FIG. 1.

When an overvoltage occurs at the terminals of the installation 2, and thus at the terminals 10A, 10B of the pre-triggering circuit, 10, this overvoltage is sufficient to make the voltage cut-off element G change from a non-conductive state to a conductive state, the lightning strike current associated with this overvoltage flows into branch B of the pre-triggering circuit 10 and especially into the primary coil L1 of transformer TR, generating a voltage at the terminals of secondary coil L2 sufficient to ensure that the main spark gap E1 arcs. Once the main spark gap E1 has arced, the voltage limiting element V1, mounted in series with voltage cut-off element G, cuts off the current circulating in the voltage cut-off element G and, more generally, in branch B of pre-triggering circuit 10.

The device for protecting against overvoltage in accordance with the present invention, therefore, has the advantage of not consuming any leakage current when permanently powered and in the absence of voltage surges.

Another advantage of the protection device in accordance with the present invention is that the protection device permits substantially all the lightning strike current to be channeled to the main spark gap E1, so that minimal lightning current flows through all or part of the pre-triggering circuit 10.

The present invention may be used in the design, manufacture and use of devices for protecting against overvoltage.

1. A device for protecting an electrical installation against overvoltage, in particular transient overvoltages due to lightning strikes, wherein the device bypasses the electrical installation, the device comprising:
a) a main spark gap, and
b) a pre-triggering circuit that is sensitive to overvoltage, the pre-triggering circuit bypassing the electrical installation and connecting to the main spark gap so that the pre-triggering circuit controls the striking of the arc in the main spark gap when an overvoltage occurs,
wherein the pre-trigger circuit comprises at least one voltage cut-off element specifically designed to change state when the voltage at the terminals exceeds a pre-determined threshold value, from a non-conductive state, in which the voltage cut-off element prevents current from circulating, to a conductive state, in which the voltage cut-off element permits current to circulate, wherein the voltage cut-off element prevents, in the non-conductive state, the current from circulating in the pre-trigger circuit so that in the absence of an overvoltage, the leakage current consumed by the pre-trigger circuit is substantially nil.

2. The device of claim 1, wherein the pre-triggering circuit comprises a triggering transformer equipped with a primary coil and a secondary coil wherein the secondary coil connects to the main spark gap so that the voltage induced at the terminals of the secondary coil causes the main spark gap to arc when the primary coil is crossed by a current.

3. The device of claim 2, wherein the main spark gap comprises at least two main electrodes; and the secondary coil is connected to one of the main electrodes.

4. The device of claim 2, wherein the main spark gap comprises a pre-triggering element to which the secondary coil is connected.

5. The device of claim 2, wherein the pre-triggering circuit comprises a branch connected in parallel to the main spark gap, the branch further comprising the primary coil and the voltage cut-off element connected in series to the primary coil and specifically positioned so that the leakage current in the entire pre-triggering circuit is substantially nil in the absence of a voltage surge.

6. The device of claim 1, wherein the pre-triggering circuit comprises at least one voltage limiting element connected in series to the voltage cut-off element.

7. The device of claim 6, wherein the voltage limiting element is formed by a varistor.

8. The device of claim 2, wherein the pre-triggering circuit comprises at least one additional voltage limiting element of the varistor type connected in parallel to the primary coil.

9. The device of claim 1, wherein the pre-triggering circuit comprises at least one component for protecting against overvoltage connected in series to the voltage cut-off element.

10. The device of claim 9, wherein the component for protecting against overvoltage is a thermal fuse.

11. The device of claim 7, wherein the thermal fuse is physically positioned against the variable resistor.

12. The device of claim 2, wherein the pre-triggering circuit comprises two voltage cut-off elements connected in series with the primary coil and positioned electrically on either side of the primary coil so that the transformer is isolated from the rest of the components of the pre-triggering circuit.

13. The device of claim 12, wherein the pre-triggering circuit comprises two voltage limiting elements connected in series with the two voltage cut-off elements.

14. The device of claim 10, wherein the two voltage limiting elements are formed by varistors and the thermal fuse is positioned between the two voltage limiting elements and is in physical contact with the two voltage limiting elements.

15. The device of claim 1, wherein the voltage cut-off element is formed by a spark gap.

16. The device of claim 3, wherein the pre-triggering circuit comprises a branch connected in parallel to the main spark gap, the branch further comprising the primary coil and the voltage cut-off element connected in series to the primary coil and specifically positioned so that the leakage current in the entire pre-triggering circuit is substantially nil in the absence of a voltage surge.

17. The device of claim 4, wherein the pre-triggering circuit comprises a branch connected in parallel to the main spark gap, the branch further comprising the primary coil and the voltage cut-off element connected in series to the primary coil and specifically positioned so that the leakage current in the entire pre-triggering circuit is substantially nil in the absence of a voltage surge.

18. The device of claim 10, wherein the thermal fuse is physically positioned against the variable resistor.

19. The device of claim 13, wherein the two voltage limiting elements are formed by varistors and the thermal fuse is positioned between the two voltage limiting elements and is in physical contact with the two voltage limiting elements.
